(19) United States
(12) Patent Application Publication
(10) Pub. No.: US 2025/0320698 A1
(43) Pub. Date: Oct. 16, 2025

(54) WATER BOTTLE

(71) Applicant: Vassr LLC, Seattle, WA (US)

(72) Inventors: Erik RICHARDSON, Seattle, WA (US); Scott James HEALY, Seattle, WA (US); Carter Douglas HEIKKILA, Seattle, WA (US); David Barnes YANCEY, Seattle, WA (US); Justin Matthew KNOWLES, Seattle, WA (US)

(21) Appl. No.: 19/176,714

(22) Filed: Apr. 11, 2025

Related U.S. Application Data
(60) Provisional application No. 63/633,231, filed on Apr. 12, 2024.

(51) Int. Cl. E03B 3/30; A45F 3/16; C02F 1/32

(52) U.S. Cl. CPC E03B 3/30; A45F 3/16; C02F 1/325; C02F 2201/3222; C02F 2201/326; C02F 2303/04; C02F 2307/02

(57) ABSTRACT

A portable water bottle includes a base or housing and a double-walled vessel coupled to the base. The base houses a battery and a controller in communication with a user interface on an exterior of the portable water bottle. A heating element is positioned internal to the double-walled vessel and is operable to melt snow or ice, or both, into additional drinking water under direction of the controller and input from the user. The water bottle also includes a UV cleaning system that is managed by the controller. A lid is removably coupled to the container to selectively provide access to the container drinking water and loading snow or ice, or both, into the container. The lid is a scoop that assists with loading snow or ice, or both, into the container.

### BACKGROUND

### Technical Field

The present application is generally directed to a water bottle, and more particularly, but not exclusively, to a portable water bottle capable of melting snow and/or ice to produce water for drinking.

### Description of the Related Art

The volume and weight of a backpack for a day trip in the back country during the winter is a known issue for various recreational activities, including hiking, skiing, snowshoeing, and others. For example, if the pack is too large and/or too heavy, the user will tire more quickly and expend additional energy to carry the pack throughout the day. On the other hand, if the pack is too small and/or too light, there may not be sufficient space for critical gear and supplies. Water is often one of the most voluminous and heaviest items in the pack, and the volume of water to bring on a backcountry day trip is a particularly difficult item to plan given uncertainties that may arise during a given backcountry activity. Bringing too little water to save space and weight in a pack can lead to the user not having enough water and thus becoming dehydrated. On the other hand, bringing too much water can result in the pack being too large and/or too heavy, thus leading to the concerns above.

A current proposed solution to this issue is to bring a combustible fuel source and materials to heat or melt snow and/or ice during a trip to produce additional water. However, this solution has a number of deficiencies and drawbacks. For example, the materials to boil water take extra space in the pack. Further, a critical aspect of this solution is a reliable source of flame to ignite the fuel source, such as a lighter or matches, which can create additional risk if the source of flame is damp or wet, not operational, and/or misplaced. Finally, the act of heating snow or ice to produce water is time consuming and, because it often involves an open flame, requires the user to stay in one place while the activity takes place. In other words, heating water with conventional fuel sources is not a mobile activity that detracts from the plan in the backcountry (i.e., users must account for time when they will be stationary to heat the snow and/or ice to produce more water). The period of inactivity associated with heating snow and/or ice can also lead to inconveniences, and in some cases, health concerns, with regulating body temperature in cold conditions.

Accordingly, it would be advantageous to have devices, systems, and methods for producing water from snow and/or ice that overcome the deficiencies and advantages of known solutions.

### BRIEF SUMMARY

The present disclosure is generally directed to a water bottle, and more particularly, but not exclusively, a portable water bottle that is capable of melting snow and/or ice into additional drinking water. The water bottle may include a hollow container or vessel with a heating element in direct contact with a material in the container, such as snow and/or ice, to melt the material via power provided by a battery internal to a housing or base below the container. The water bottle may also be a double-walled vessel or container with material contained in the inner vessel and heating elements applied to outer walls of the inner vessel. The inner vessel and heating elements are surrounded by insulation and an outer vessel. Where the material is snow and/or ice, the snow and ice are melted and the water is heated to a temperature below boiling. A switch in communication with the battery and the heating element selectively turns the heating element ON and OFF, or selectively provides power from the battery to the heating element. The water bottle contemplated herein is capable of carrying and producing more water than its volume (i.e., by refilling the water bottle with water via melting of snow and/or ice) to save space and weight in a pack relative to traditional solutions of carrying sufficient drinking water.

In one or more implementations, a portable water bottle may be summarized as including: a base; a container coupled to the base; a heating element within the container; and a lid removably coupled to the container to selectively provide access to the container, wherein the lid is a scoop for assisting with loading of snow or ice, or both, into the container to produce additional drinking water via the heating element.

In an aspect, the base is removably coupled to the container and the portable water bottle further includes: a battery received in the base and in electronic communication with the heating element; and a switch on an outer surface of the at least one of the base and the container, the switch in electronic communication with the battery to selectively turn the heating element ON and OFF.

In an aspect, the lid includes an elongated portion having a length greater than a circumference of the lid.

In an aspect, the lid has a cylindrical shape with a diagonal bevel that defines the elongated portion.

In an aspect, the diagonal bevel of the lid is at an angle between and including 30 degrees and 60 degrees relative to horizontal.

In an aspect, the heating element extends into a hollow interior of the container in direct contact with water, snow, ice, or a combination thereof in the hollow interior of the container.

In an aspect, the heating element is a resistive coil.

In an aspect, the portable water bottle is configured to provide an amount of drinking water that is greater than a volume of the portable water bottle via melting of snow or ice, or both.

In an aspect, the heating element is configured to melt snow or ice, or both, while the portable water bottle is stored in a pack.

In one or more implementations, a portable water bottle may be summarized as including a heating element in direct contact with water, snow, ice, or any combination thereof inside the portable water bottle.

In one or more implementations, a device may be summarized as a portable water bottle including a lid that is a scoop for loading snow or ice, or both, into the portable water bottle, wherein the portable water bottle is configured to melt the snow or ice, or both, into additional drinking water.

### BRIEF DESCRIPTION OF THE SEVERAL VIEWS OF THE DRAWINGS

FIG. 1 is an isometric view of an implementation of a water bottle according to the present disclosure.

FIG. 2 is a cross-sectional view of the water bottle of FIG. 1 along line A-A in FIG. 1.

FIG. 3 is a partially exploded view of the water bottle of FIG. 1.

FIG. 4 is an isometric view of a lid of the water bottle of FIG. 1.

FIG. 5 is a schematic cross-sectional view of an implementation of a water bottle with a double-walled vessel according to the present disclosure.

FIG. 6 is a schematic view of a controller capable of implementing at least some of the techniques described herein.

### DETAILED DESCRIPTION

Persons of ordinary skill in the relevant art will understand that the present disclosure is illustrative only and not in any way limiting. Other implementations of the presently disclosed devices, systems, and methods readily suggest themselves to such skilled persons having the assistance of this disclosure.

Each of the features and teachings disclosed herein can be utilized separately or in conjunction with other features and teachings to provide water bottle devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. The dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to a water bottle that is capable of melting snow and/or ice to produce additional water for drinking. The concepts presented herein preferably do not rely on an active flame or other combustible heat source, but rather, use a battery-powered heat source to enable heating of the snow and/or ice to produce water while the water bottle is stored in the user's pack, thus enabling the user to be mobile while the water bottle is producing additional water. Such an arrangement may be particularly advantageous for producing water for a return portion of a day trip. In one non-limiting example, before leaving for the day, the user would fill the water bottle with drinking water. The user consumes the water on the way to the location in the backcountry. The user then loads the empty water bottle with snow and/or ice. While the user is performing a backcountry activity, the water bottle melts the snow and/or ice to produce additional water for the return trip. Many other features and advantages of the technology will be described with reference to the accompanying figures. Unless otherwise noted, the concepts presented herein can be applied equally to other types of water bottles, and even outside of the field of water bottles and drinking vessels.

Unless the context dictates otherwise, the phrase “water bottle” should be construed broadly to mean any device, vessel, or container for carrying water or capable of carrying water, and includes vessels or containers with or without lids as well as vessels or containers formed of any material now known or developed in the future, whether insulated or uninsulated. The word “vessel” has a similar meaning to “water bottle” unless otherwise noted.

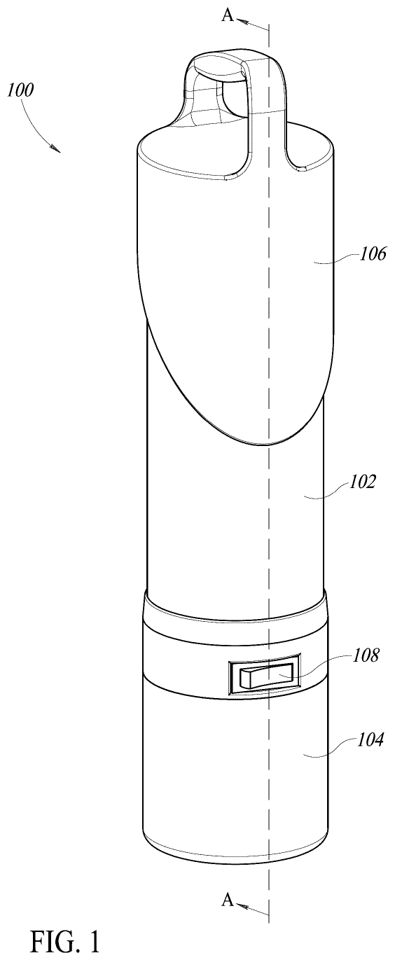

FIG. 1 is an isometric view of an implementation of a water bottle 100. The water bottle 100 includes a container 102, a base 104, and a lid or cap 106. The container 102 (as well as the water bottle 100 generally) may have a cylindrical or other selected shape and, as further described herein, may be a hollow vessel for receiving and storing a liquid such as water. The base 104 is permanently or removably coupled to a bottom of the container 102 and may house a battery, control hardware, or other like aspects of the water bottle 100. The lid 106 is removably coupled to a top of the container 102 to selectively seal the container 102 and contain water (or another liquid) within the container 102. As will be described further herein, the lid 106 also functions as a scoop to assist a user with loading snow and/or ice into the container 102.

FIG. 1 further illustrates that the water bottle 100 includes a switch 108 on an exterior surface of the water bottle 100, such as a rocker switch, that turns the water bottle 100 ON or OFF. The switch 108 may also be another type or form of user actuatable control, whether manual or a touch sensitive control. For example, the switch 108 may instead be a touch sensitive power button, another form of a manual, non-touch sensitive switch, or another like device. Although FIG. 1 illustrates that the water bottle 100 includes only a single switch 108, additional implementations may include additional switches or other user actuatable controls that enable user control of additional characteristics or functions of the water bottle, such as a low or high power mode that changes a rate at which the water bottle 100 melts snow and/or ice, a time delay and/or scheduling function, and activating heating of the material in the water bottle 100, among many others. In an implementation, the water bottle 108 further includes a cover for the switch 108 to prevent inadvertent actuation of the switch 108 while the water bottle 100 is in a pack and/or not in use.

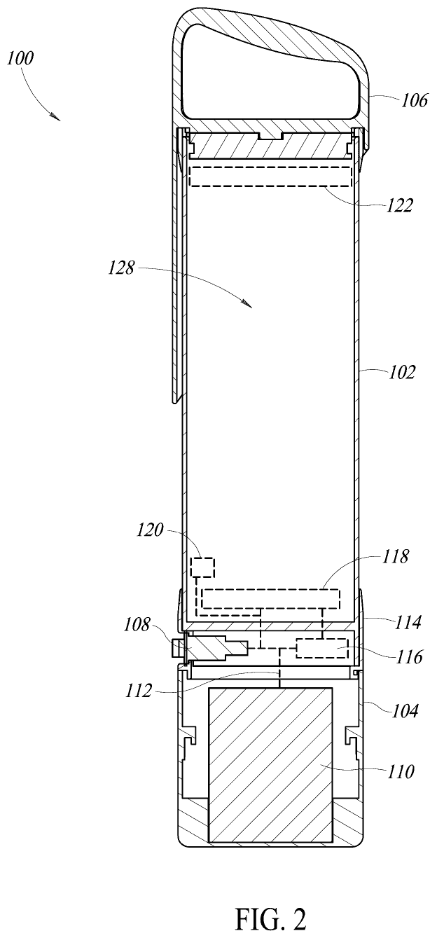

FIG. 2 is a cross-sectional view of the water bottle 100 along line A-A in FIG. 1. With continuing reference to FIG. 1, the container 102 and the base 104 may both be hollow. As noted, the container 102 is configured to receive and store water as well as snow and/or ice that is to be melted into additional water. The base 104 is coupled to the container 102 and houses a battery 110 internal to the base 104 and below the container 102. In an implementation, the seal between the base 104 and the container 102 is a hermetic seal or waterproof seal to prevent any liquid from escaping the container 102 and coming into contact with the battery 110. Additionally or alternatively, the battery 110 may be waterproof or may have a waterproof and/or hermetic seal or coating to prevent ingress of liquid into the battery 110. The base 104 may preferably be removably coupled to the container 102 to enable the base 104 to be removed for replacement or repair of the battery 110 and control electronics of the water bottle 100, but the same is not necessarily required and the base 104 may be permanently coupled to the container 102, such as to accomplish the waterproof or hermetic seal.

In an implementation, the battery 110 may be more generally referred to as a power source and may include any number of different configurations of rechargeable or non-rechargeable (or disposable) batteries. For example, the battery 110 may be one or more disposable and replaceable batteries of a standard size, such as AA, C, D, and others. More preferably, the battery 110 is a rechargeable battery, such as a lithium-ion battery. The water bottle 100 may include a charging contact or connecter input on a side or bottom of the water bottle 100 for charging the battery. Even where a lithium-ion rechargeable battery is used, the battery 110 may still be removable and replaceable, such as if the user desires to bring an extra battery to produce more water. In cold conditions, initial testing demonstrated that battery capacity at 32 degrees F. (0 degrees C.) was 80% of the stated capacity and at 14 degrees F. (−10 degrees C.), the capacity reduced to 70%. As a result, the battery 110 is preferably selected to have an energy capacity that corresponds to 70% capacity being sufficient to melt approximately 1 liter of snow and/or ice to produce water. Thus, the battery capacity may exceed, when temperatures are 32 degrees F. or higher, the amount of capacity needed to melt a desirable amount of snow and/or ice. Thus, in some implementations, a user may be able to melt more than one container 102 of volume of snow and/or ice on a single charge of the battery 110 and/or with a single battery 110. Advancements in battery technology may enable higher yields (i.e., multiple heating cycles per charge or per battery). In some implementations, such a battery may be a 0.5 kg battery with a 110 Wh rating and approximately 10.5 volts output.

FIG. 2 further illustrates dashed lines between the switch 108, the battery 110, and additional control electronics that will be described in more detail below. The dashed lines represent communication between the various hardware aspects of the water bottle 100 and should be construed to include wired or wireless communication between various components. For example, the switch 108 may be electrically coupled or in electronic communication with the battery 110 via a wire represented in FIG. 2 with dashed lines 112. In an implementation, the switch 108 is mounted to an external or outer surface of a housing 114 that is coupled to a bottom of the container 102 with the base 104 coupled or removably coupled to the housing 114. The housing 114 is preferably sealed to the container 102 with a waterproof and/or hermetic seal. The housing 114 may be open to the hollow base 104, such that the interior of the housing 114 and the base 104 are in communication with each other and allow a wire to extend from the switch 108 directly to the battery 110. In an implementation, the wire may instead pass through a wall of the housing 114 and/or the base 104 to reach the battery 110. Other configurations are contemplated herein.

The switch 108 and battery 110 may also be in communication with a controller 116 illustrated schematically with dashed lines. The dashed lines of the controller 116 generally indicate that the controller 116 may be positioned in a selected location along the water bottle 100 as well as the components or aspects of the controller 116 may vary between implementations. In an implementation, the controller 116 may be omitted to simplify the overall assembly of the water bottle 100. In implementations that include the controller 116, the controller 116 may include at least one processor and one or more storage media, such as ROM, RAM, and/or flash memory, that store instructions which, when executed by the at least one processor, cause the water bottle 100 to perform certain functions. For example, the storage media may store instructions that, when executed by the at least one processor, cause the battery 110 to vary a power level to vary a rate at which the water bottle 100 melts snow and/or ice. The controller 116 may also optionally include wireless transmitters, receivers, and/or transceivers for enabling wireless communication with one or more external devices, such as a user's smartphone or personal computer, as well as a broader network of interconnected devices. Such may be useful for providing an alert to a user's mobile phone (i.e., via a mobile software application) that the water bottle 100 has finished heating snow and/or ice (i.e. finished producing drinkable water), as well as storing and transmitting the amount of time the water bottle 100 has been operational in addition to remaining battery power and other characteristics of the water bottle 100. In some implementations, the controller 116 includes, or is in communication with, various sensors for providing data to the user regarding the water bottle 100, including those aspects mentioned above and others. Many other configurations of the controller 116 and associated functions of the controller 116 and/or water bottle 100 are contemplated herein.

The switch 108 and battery 110 may also be in communication with a heating element 118, either directly or through the controller 116. The heating element 118 is preferably a resistive coil or other like heating element 118, although the disclosure also contemplates other types of heating elements 118, such as at least a resistive sheet, a ceramic radiant heater, an inductive heating element, an infrared bulb (or other light source), and others. The heating element 118 is positioned internal to, or within the container 102, meaning that the heating element 118 is inside the container 102 and in direct contact with a material, such as water, snow, and/or ice, in the container 102. As a result, the heating element 118 may preferably be separated from the switch 108, battery 110, and controller 116 at least by an outer wall (i.e., a top wall in some implementations) of the housing 114 and/or the base 104. Although the heating element 118 is preferably positioned at a bottom of the container 102 so that it is in contact with the coldest and densest material in the container (i.e., in contact with denser snow and/or ice as it melts to produce water), the position of the heating element 118 in the water bottle 100 as well as the other components described herein can generally be selected.

In an implementation where the heating element 118 is a resistive coil, the water bottle 100 preferably maintains a heat sink to prevent thermal runaway of the coil. The heat sink may be separate and distinct component of the water bottle 100, or may be implemented by water in the container 102 sufficient to at least partially, or more preferably entirely, submerge the resistive coil. To this end, the container 102 may include a water sensor 120 that is in electrical communication with the controller 116 and/or the battery 110. The water sensor 120 may have a position in the container that is selected to correspond to a threshold minimum amount of water in the container 102 so that the water acts as a heat sink for the coil. The water sensor 120 may take periodic readings at selected intervals or relatively continuous readings and communicate the same to the controller 116. The controller 116 may store and execute instructions based on the readings from the water sensor 120, such as turning OFF the supply of electricity from the battery 110 to the coil if the sensor 120 does not detect water. Alternatively, the controller 116 may maintain the supply electricity (i.e., the coil remains ON) if water is detected by the sensor 120 to act as a heat sink. The water bottle 100 may include a further sensor, such as a proximity or contact sensor, associated with the lid 106 such that if the lid 106 is removed, the controller 116 would likewise turn the coil OFF for safety. In additional implementations, the coil may be provided in a coil core in the center of the container 102 instead of as an exposed heating element inside the container 102.

In yet further implementations, the water bottle 100 may also include a timer or a timing circuit associated with the controller 116 and/or the battery 110 and heating element 118 to automatically turn the heating element 118 OFF after a selected interval to avoid expending too much battery capacity when snow and/or ice in the water bottle 100 are already melted and in some cases, help reduce or eliminate thermal runaway. For example, in initial testing, it was determined that a suitable maximum amount of time in various conditions (i.e., warm and cold or below-freezing external temperatures) for melting approximately 1 liter of snow and/or ice in the container 102 was between 30 minutes and 1 hour. Accordingly, the timer or timing circuit may automatically turn the heating element 118 off, such as via controller 116, after this elapsed maximum period of operation in order to conserve battery power. In other implementations where the melt time is lower, such as any of those times described herein for other battery 110 and heating element 118 configurations, the timing circuit may likewise be adjusted to turn the heating element 118 OFF after a different and selected period of time. Such adjustment may be made during manufacturing, or by the user either manually or wirelessly, such as through an associated downloadable application on an external computing device, including but not limited to, computers, smart phones, and tablets.

In another example, the water bottle 100 may include a temperature sensor in the internal cavity of the container 100, and preferably proximate a bottom of the container 100 that is in communication with the controller 116. The temperature sensor may assist with preventing the expenditure of battery capacity when the snow and/or ice in the container 102 is already melted to produce water (i.e., when there is no additional benefit to further heating). The temperature sensor may be associated with a particular temperature threshold that generally corresponds to a temperature at which all of the snow and/or ice may be melted and/or may take temperature readings over time to determine when the snow and/or ice are melted and the heating element 118 should be turned OFF. For example, when snow and/or ice are loaded into the container 102 with remaining water and begin to melt, the initial water that is produced will continue to be cooled despite the heat input from the heating element 118. As a result, it may be expected that the temperature of the water in the container 102, as detected by the temperature sensor, would around or near the freezing point of water (i.e., 0 degrees C. or 32 degrees F.) until all of the snow and/or ice is melted. Once the snow and/or ice are melted, the temperature of the water would be expected to raise due to heat input by the heating element 118 without the counteracting cooling of the snow and/or ice. Accordingly, if the temperature sensor takes regular readings (i.e., every minute or less, every 2-3 minutes, every 5 minutes, etc.), the temperature over time data can be used to determine when the temperature of the water begins to rise and remain above freezing, thus suggesting that the snow and/or ice are melted and the heating element 118 should be turned OFF, such as via controller 116, to conserve battery power. Another way to enable this functionality may be to measure change in temperature over time and turn OFF the heating element 118 when the change in temperature over time exceeds a selected threshold. Other sensors and sensor configurations are also contemplated herein.

In an implementation where the heating element 118 is instead a resistive sheet, the sheet may be wrapped around an outside of at least a portion of, or all of, the container 102 or may be placed inside the container 102 and in contact with the snow and/or ice. The heating element 118 as one or more infrared bulbs may be implemented inside the container with light radiated from the bulb directly onto the snow and/or ice.

Initial testing showed that a resistive coil in direct contact with the snow and/or ice in the container 102 is a preferred implementation to enable the benefits and advantages described herein. The resistive coil provided an efficiency of melting ice of approximately 78.8% to 91% while the resistive sheet had an average efficiency of around 69.9%. The infrared bulb was less efficient at around 13%. In the above test results, efficiency was calculated by watts or watt hours utilized from a power source divided by total watt hours needed to fully melt ice loaded in the vessel. For example, for the resistive coil, 26 watt hours from the power source were used to fully melt (i.e., all solid ice in liquid form based on visual inspection) 410 g of ice with 100 g of water whereas the total watt hours used (including watts contributed by environment) was 33 watt hours in one experiment. As a result, 26 watt hours divided by 33 watt hours yields a 78.8% efficiency. Implementing the water bottle 100 with a resistive coil as the heating element 118 in direct contact with the snow and/or ice improved performance relative to the resistive sheet because the coil is in direct contact with the material to be heated, which minimizes losses to surrounding material (i.e., material of the container 102 and/or water bottle 100) as well as to the environment that are apparent from the lower efficiency of the resistive sheet testing. A further benefit of a resistive coil is that it is able to operate and efficiently melt snow and/or ice at lower liquid levels in the container 102 as well as being more efficient at melting ice relative to a resistive sheet. While a resistive coil is preferred, the above summary is in no way limiting and each of the alternatives presented herein may be selected for inclusion in the water bottle 100 alone and/or in combination with other heating devices, particularly in different configurations or by utilizing advancements in technology that may change the above initial understanding of the preferred benefits of the resistive coil (i.e., advancements in resistive sheets in the future may instead suggest a resistive sheet is a preferred implementation).

In an implementation, the water bottle 100 further includes a filter 122 that may take a variety of forms. For example, the filter 122 may be removably coupled to an open top of the container 102 and may have a generally circular or cylindrical shape so that the filter extends horizontally to close and/or seal (except for passageways through the filter 122) the open top of the container 102 in use to force water to flow through the filter 122 before escaping the container 102. In such a non-limiting example, the filter 122 can be removed for the loading of snow and replaced after the container 102 is sufficiently filled with snow to filter particulate matter that may be present in the melted water before the user drinks the water. In other words, the water passes through the filter 122 before it reaches the user. The filter 122 may have a selected mesh size or pass-through rate and may generally be a metal filter, an activated carbon filter, a mechanical filter, an absorption filter, a sequestration filter, an ion exchange filter, a reverse osmosis filter, or some other type or form of filter that is suitable for use in filtering water. In further implementations, the water bottle 100 may optionally include an ultraviolet light or some other water purification device or method that may be in communication with the controller 116 and selectively activated, either manually by the user or automatically, to purify the water before consumption by the user.

In yet further examples, the filter 122 may take a different form than a filter 122 that is removably coupled to a top of the container 102. For example, the filter 122 may instead extend vertically through the container 102 to separate the container into one or more subsections. Snow and/or ice can be loaded into the container 102 on one side of the filter 122 and water can be consumed from an opposite side of the filter 122 such that any water consumed must pass through the filter 122. Other configurations are contemplated herein.

The present disclosure also contemplates a mixing device inside the container 102, including a paddle mixer, an agitator, or another like device that is driven by an electric motor or electric drive assembly via power from the battery 110 in order to increase melt speed and/or efficiency of the snow and/or ice in the container 102.

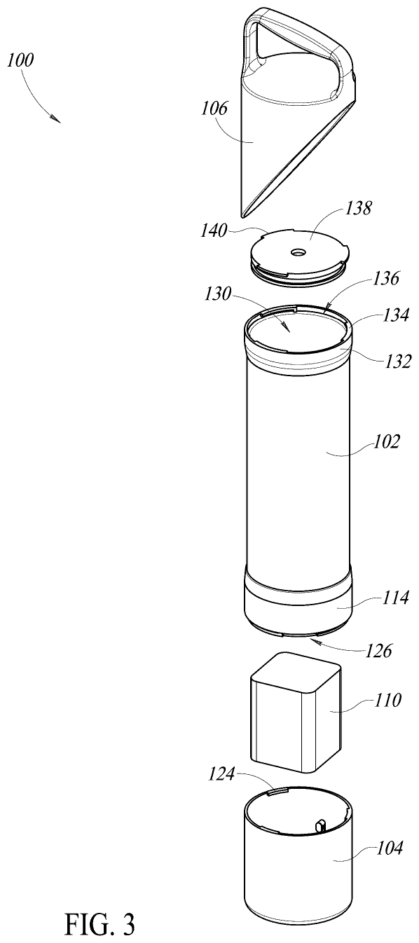

FIG. 3 is a partially exploded view of the water bottle 100. FIG. 3 is “partially” exploded in the sense that not all features or aspects of the water bottle 100, such as the switch 108, are shown exploded. Instead, selected aspects are exploded to provide more information regarding the water bottle 100. As noted, the water bottle 102 includes the container 102 and the housing 114 which may be removably or permanently coupled to the container 102. The base 104 may be removably coupled to the container 102 and/or housing 114 by a twist to lock assembly, or with other fastening systems, devices, and methods, including but not limited to a friction fit, fasteners, a threaded connection, magnets, adhesives, and the like. The base 104 may include ridges or flanges 124 that are received in corresponding channels or holes 126 in the container 102 and/or housing 114 with the base 104 then rotated to engage the flanges 124 of the base 104 with corresponding structures on the container 102 and/or housing 114.

The container 102 may be enclosed, except for an open top. More specifically, the container 102 may have a longitudinal axial bore 128 (FIG. 2) extending into, but not through, the container 102 that defines the hollow interior volume of the container 102. In an embodiment, the bore 128 extends through the container 102 and the container 102 is closed at the bottom by an additional plate and/or an outer wall of the housing 114 or some other aspect of the water bottle 100. The bore 128 leads into an opening 130 at the top of the container 102 that facilitates drinking of water from the container 102 as well as loading of snow and/or ice into the container 102 during use. The opening 130 may be surrounded by a ring 132 coupled to the container 102 that includes flanges or ridges 134 with spaces or channels 136 therebetween. The lid 106 may include a plug 138 coupled to, and preferably permanently coupled to, an interior wall of the lid 106. The plug 138 includes corresponding flanges or ridges 140 that selectively engage the spaces or channels 136 in the ring 132 of the container to selectively engage the container 102 and close the opening 130 in a twist to lock manner described herein. Other configurations and attachment devices, systems, and methods for removably coupling the lid 106 to the container 102 are considered herein, including at least a hinged connection, a threaded connection, and the other fastener variants described above, among others. Accordingly, in use, the user may rotate the lid 106 to remove the lid 106 from the container 102 to selectively provide access to the opening 130 to enable drinking water from the container 102 or loading snow and/or ice into the container 102. Once the user is finished, they replace the lid 106 and twist to lock the lid 106 to the container 102.

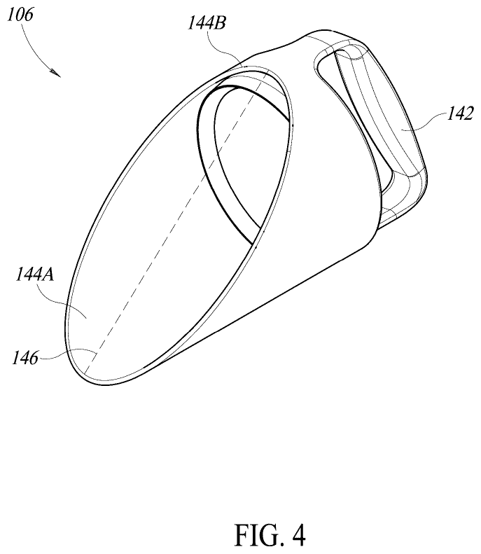

FIG. 4 is an isometric view of the lid 106, which may also be referred to herein as a scoop 106 or lid 106. The lid 106 serves a dual function of selectively closing the container 102 (FIG. 3) as well as assisting a user with loading snow and/or ice into the container 102. Specifically, the lid 106 includes a handle 142 that enables a user to grasp the lid 106 and manipulate the same in use as a scoop or shovel for loading snow and/or ice into the container 102. The lid 106 has a generally hollow cylindrical shape that is open at one end with a diagonal cut or bevel across the body of the lid 106 to provide the lid 106 with a tapered shape shown in FIG. 4. In particular, the lid 106 may include a first or outer end 144A and a second or inner end 144B where the first end 144A is spaced from the handle 142 across the lid 106 and the second end 144B is adjacent and fixed to the handle 142. The first end 144A has a length relative to the second end 144B that may be greater than a diameter of the lid 106 in some embodiments in order for the lid 106 to function as a scoop, as described herein. The length of the lid 106 from the first end 144A toward the second end 144B tapers around the circumference of the lid 106 according to the diagonal cut along the lid 106 to assist with loading the lid 106 with snow and/or ice. In an implementation, a tangent line (represented by dashed line 146) through a center of the lid 106 and touching opposite edges of the opening of the lid 106 at the first elongated end 144A and the second end 144B is at an angle to horizontal that may be between 30 degrees and 60 degrees, or more or less, to provide the lid 106 with a generally triangular cross section.

In sum, and in operation, a user accesses the container 102 to drink water by removing the lid 106, which may include rotating the lid 106 relative to the container 102, as described herein. When the user desires to create additional water, the user uses the lid 106 as a scoop to shovel snow and/or ice into the container and replaces the lid 106. The user then manipulates the switch 108 to the ON position to begin heating and melting the snow and/or ice. The water bottle 100, and specifically the heating element 118, heats the snow and/or ice with electricity provided by the battery 110 to produce additional drinking water. In some implementations, the battery 110 may provide sufficient electricity to melt an entire container 102 or more worth of snow and/or ice (i.e., at least 1 liter) to produce an equivalent amount of water. Preferably, the water bottle 100 is capable of melting sufficient snow and/or ice to produce an additional 1 liter of drinking water or an additional 2-3 liters of drinking water in various implementations. The water bottle 100 may melt such snow and/or ice in a period of time of one hour or less, or 45 minutes or less, or 30 minutes or less, or 20 minutes or less depending on characteristics of the battery 110 and heating element 118. As a result, the water bottle 100 can be stored while the heating element 118 melts the snow and/or ice to produce additional water, thus freeing the user to continue performing an activity rather than stopping and waiting for a conventional fuel source to melt the snow and/or ice.

In view of the above, the water bottle 100 contemplated in FIGS. 1-4 may have a volume equivalent to that of a 1.5 liter bottle with the container 102 generally being 1 liter while the battery 110 and control electronics occupy 0.5 liters in a non-limiting example. Other sizes are contemplated. The water bottle 100 is capable of melting additional snow and/or ice to produce at least an additional liter of water on a single charge and may be capable of producing additional water beyond an additional liter depending on battery configurations or bringing one or more additional replacement batteries. Thus, the water bottle 100 is capable of providing at least 2 liters of water when started as a full vessel in a package that occupies 1.5 liters of space, thus saving 0.5 liters of space (and associated weight, which may be 0.5 kg or more) relative to bringing two liters of water, all of which are important factors for backcountry activities for the reasons provided herein. The water bottle 100 is also a mobile device and does not require the user to stop and heat water during a day trip, which allows the user to maximize their time carrying out a given activity and avoid concerns about being too cold during a stopping period as well as maintaining a source of flame to ignite a combustion source. As a result, the concepts of the disclosure provide for a mobile water production solution that is capable of carrying and/or producing more water than its volume in order to save space and weight in a pack.

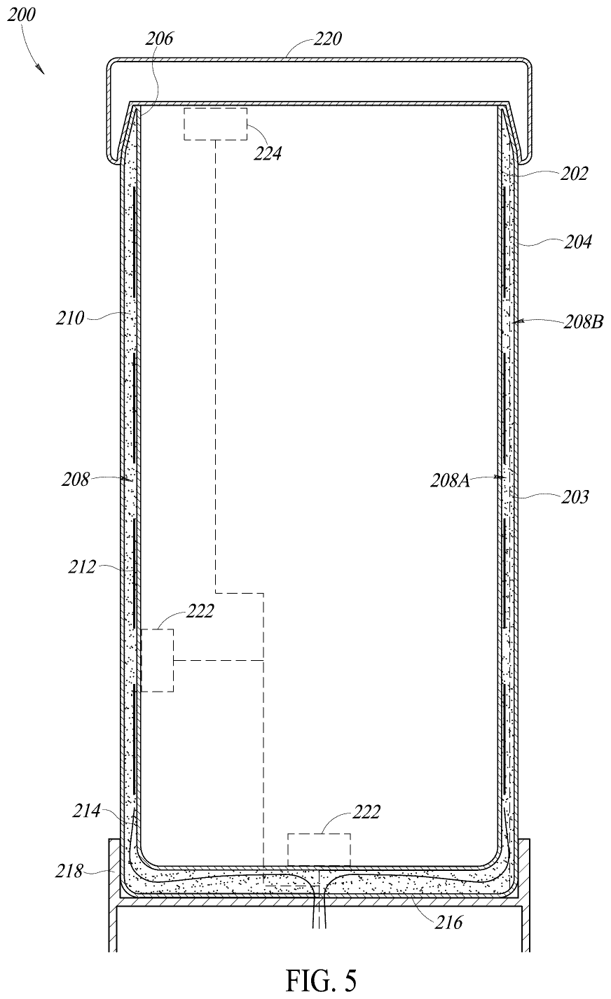

FIG. 5 is a schematic cross-sectional view of a further implementation of a water bottle 200. The water bottle may be similar to the water bottle 100, except as described below. The water bottle 200 includes a double-walled vessel including an inner vessel 202 received inside of an outer vessel 204. The inner and outer vessels 202, 204 are coupled together in a fluid-tight manner at their respective longitudinal ends, such as at least their upper ends 206. The inner vessel 202 has a smaller volume than the outer vessel 204 such that there is an enclosed space 208 between the inner and outer vessels 202, 204. The inner vessel 202 is structured to hold material (i.e., snow and/or ice) to be melted while the outer vessel 202 protects the inner vessel 202 and additional internal components, as described below. The space 208 may be filled with air at ambient or vacuum pressure (i.e., less than ambient pressure) and/or may include insulation 210.

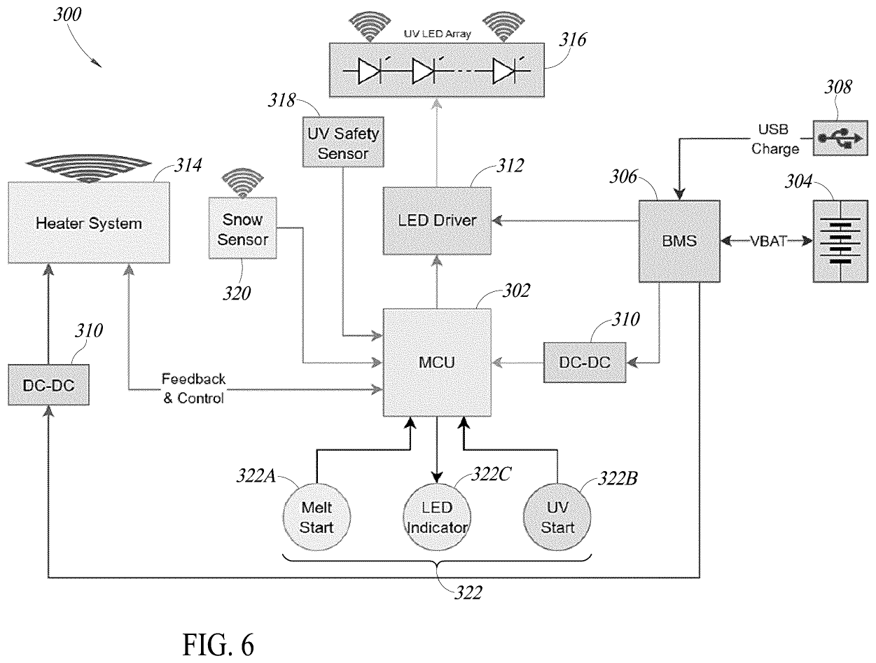

One or more heating elements 212 are positioned around or on the exterior wall or surface of the inner vessel 202. The heating elements 212 are preferably a flexible polyamide heating element, although others may be acceptable. Such flexible polyamide heating elements wrap around the outside of the inner vessel 202 and are divided into segmented regions for control as snow melts. The flexible polyamide heating elements may also include integrated temperature sensors that provided feedback to the controller described in FIG. 6 to enable protection of the heating elements 212 from over-heating and may also be used for sensing snow. The insulation 210 is positioned around the heating elements 212 (or heater) to direct the heat into the snow and/or material in the inner vessel 202. A number of different types of insulation are available and suitable for this purpose, including at least various types of silicone insulation.

As shown in FIG. 5, there are four heating elements 212 spaced equidistant from each other along a height of the inner vessel 202. Other numbers and configurations of the heating elements 212 are contemplated. Where insulation 210 is included, the insulation 210 surrounds the heating elements 212 and fills all of the enclosed space 208 or at least all of the enclosed space 208 along the sidewalls of the inner vessel 202. Snow and/or ice will float on top of water in the inner vessel 202 during use of the water bottle 200. As a result, the heating elements 212 are positioned along a height of the water bottle 200 and specifically the inner vessel 202 to enable a modular and flexible heating system that can turn sections ON and OFF depending on the orientation of the bottle 200 and/or melting progress, as further described below. Thus, the heating elements 212 that are closest to or correspond to a position of the snow in the inner vessel 202 can be turned ON while other heating elements 212 that are further from the snow or spaced from the snow can be turned OFF. The selectivity in operation of the heating elements 212 enables more efficient and effective heating while also conserving battery power, thus enabling the water bottle 200 to produce additional water on a single charge, such as at least 2-3 liters of water. The heating elements 212 can be electrically coupled to each other in series or may be electrically isolated to further support selectivity in operation. In any event, the heating elements 212 are electrically coupled to a power source, such as the batteries discussed herein, through wires 214. The wires 214 travel through the space 208 between the inner and outer vessels 202, 204 and exit through a base or bottom 216 of the double-walled vessel to connect to the power source that may be positioned in a housing 218 under the double-walled vessel.

In addition, the water bottle 200 includes a lid 220 coupled to a top of the double-walled vessel to enclose the same. The water bottle 200 preferably includes a UV sanitation system for killing bacteria, viruses, and other harmful contaminants in the melted water in the inner vessel 202. The UV sanitation system preferably utilizes UV-C light to kill bacteria provided by an array of UV-C LEDs 222. The UV-C LEDs 222 (“LEDs 222”) are represented schematically by dashed boxes to represent that the number and location of the LEDs 222 may vary. For example, the LEDs 222 may include a 3 LED array for uniform coverage throughout the water bottle 200. The LEDs may be positioned at any selected location in the water bottle 200, including, but not limited to, inside the inner vessel 202 on the sidewalls or bottom of the inner vessel 202, in the enclosed space 208, and/or on the lid 220. It may also be possible to include the LEDs 222 on interior walls of the outer vessel 204 provided that there is a suitable path for the UV-C light to reach the water inside the inner vessel 202. Similarly, if the LEDs 222 are located in the enclosed space 208, the inner vessel 202 may preferably be a UV-transparent material or include UV-transparent windows aligned with the light output by the LEDs 222 to enable the light to impinge upon the water inside the inner vessel 202. Where the LEDs 222 are inside the inner vessel and/or on the lid 220, the LEDs 222 are preferably enclosed in a water-proof or water-tight housing that is UV-C transparent.

In an implementation where the water bottle 200 includes a 3 LED array, the array may irradiate the vessel at 265 nm for peak disinfection. The expected power consumption of such irradiation is 100-200 mW UV-C for a 60 second disinfection cycle. To help agitate the water and increase the efficacy of removal of bacteria, the user may be instructed to shake the water bottle 200 during the disinfection cycle. Further, the LEDs 222 may be driven by one or more constant current LED drivers to compensate for voltage drop variability of UV-C LEDs and improve performance. Because UV-C light can be harmful to the user, the water bottle 200 also includes a safety switch 224 or interlock to ensure that the UV-C cleaning system or subsystem is not activated when the lid 220 is not secured to the water bottle 200.

The safety switch 224 can be any one or more of a strain gauge to detect when the lid 220 is screwed onto the vessel, a switch in the top of the vessel covered by a waterproof membrane or flexible plastic and/or metal, a magnetic switch interface activated by a piece of metal in the lid, a conductive switch including two or more exposed metal contacts on the vessel such that when the metal lid 220 is on the vessel, the lid 220 shorts the contacts together, and an infrared sensor that may have the dual function of detecting if snow is present and its location and if the lid 220 is in place. Each of the above are suitable alternatives to detect when the lid 220 is on the vessel and thus provide a safety function for activation or deactivation of the UV-C cleaning system. Although the LEDs 222 and safety switch 224 are illustrated as being in electrical communication (i.e., electrically connected) with dashed lines through the inner vessel 202, it is to be appreciated that the electrical connection(s) for the UV-C LEDs 222 and the safety switch 224 (as applicable) are routed through space 208 between the inner and outer vessels 202, 204.

In an implementation, the water bottle 200 includes a triple-walled vessel having the inner and outer vessels or walls 202, 204 and a middle vessel or wall 203 between the inner and outer vessels 202, 204. The middle wall 203 may be centered between walls of the inner and outer vessels 202, 2024 or may be offset or have some other selected spacing arrangement. Further the middle wall 203 separates the space 208 between the inner and outer vessels 202, 204 into two separate and fluidly isolated spaces 208A, 208B. Both the first space 208A between the inner vessel 202 and the middle wall 203 and the second space 208B between the middle wall 203 and outer vessel 204 may be filled with air at ambient pressure or vacuum or may be filled with insulation 210. In a preferred implementation, the first space 208A is filled with insulation 210 and the second space 208B is vacuum sealed such that the water bottle 200 includes two separate types of insulation to further improve heat input to the inner vessel 202 and minimize or reduce heat loss, thus optimizing performance. The insulation in the spaces 208A, 208B may also be the same type in some implementations.

FIG. 6 is a schematic view of a controller 300 suitable for implementing at least some or all of the techniques discussed herein. The controller 300 is preferably located in the housing below the vessel or is otherwise carried onboard the water bottles 100, 200 to provide for a mobile solution. The controller 300 includes a microcontroller 302 that may be a STM32F0 Series microcontroller from STMicroelectronics®, among other options. The microcontroller 302 monitors the sensors described herein and controls system functions, as further explained below. The microcontroller 302 further monitors user input to the user interface described below and provides feedback, such as lighting an LED on a button to indicate activation of certain functionality. The microcontroller 302 also controls and monitors the snow melting cycle, again using sensors described herein, and controls and monitors the UV cleaning cycle. Unless otherwise noted, the microcontroller 302 is in electrical communication with all components or aspects of the controller 300 to manage and control the operation of the same. Further, the controller 300 generally and its hardware aspects may be stored in the container or housing below the vessel, unless otherwise note (i.e., heating elements of the heater system 314 positioned around an exterior surface of the inner vessel and thus not in the container or housing).

The microcontroller 302 as well as the water bottles 100, 200 are powered or provided electrical current by a power system including a battery 304, a battery management system 306 (“BMS 306”), a charger 308, and DC-DC power converters 310. The battery 304 stores electrical energy that is managed and/or distributed by the BMS 306. The charger 308 may be a USB charging port for providing electrical energy into the battery 304 through the BMS 306. Thus, the BMS 306 controls and manages power input into and power output out of the battery 304 under directions provided by the microcontroller 302. The converters 310 are a type of power converted that converts direct current (DC) from one voltage level to another, such as a step-up or step-down converter to increase or decrease the voltage, respectively.

Accordingly, the BMS 306 is in electrical communication at least with the microcontroller 302, an LED driver 312, and a heater system 314 that may be any of the heaters described herein. The LED driver 312 drives or controls operation of an LED array 316, and in particular, a UV-C LED array 316 to selectively operate the UV-C cleaning system described herein under direction or instruction from the microcontroller 302 and/or use through the user interface described below. A UV safety sensor 318 is in communication with the microcontroller 302 to provide the safety function described herein of disabling or preventing activation of the UV-C cleaning system when the vessel is open or the lid is removed and/or not seated on the vessel. A snow sensor 320 is also in communication with the microcontroller 302 for detecting the presence and/or location of snow within the vessel for selective heating, as described above.

The controller 300 further includes a user interface 322 that includes various switches, keys, buttons, and the like for user control of the system and/or user notification of the status of the system. In particular, the user interface 322 includes at least a melt start button 322A that when depressed by the user provides instructions to the microcontroller 302 to activate the heater system 314 via power provided by the battery 304 and BMS 306. The melt cycle may run for a predetermined and set time, such as those described herein. Alternatively, the snow sensor 320 may provide data or signals corresponding to snow and/or ice being present in the vessel that is used by the microcontroller 302 to control the length of the melt cycle based on instructions or an algorithm stored in memory of the microcontroller 302 and executed by a processor of the microcontroller 302. For example, the microcontroller 302 may maintain operation of the heater 314 until the snow sensor 320 no longer detects snow and/or ice, at which point the melt cycle is immediately terminated.

Alternatively, the microcontroller 302 may maintain operation of the heater 314 until the snow sensor 320 no longer detects snow and/or ice plus a set additional operation time to ensure complete melting (i.e., an additional 1 minute, 3 minutes, 5 minutes, 10 minutes, or more or less or any time therebetween). Still further, the microcontroller 302 may maintain operation of the heater 314 until the snow sensor 320 no longer detects snow and/or ice and the water reaches a selected temperature based on feedback or data from the temperature sensor described herein, such as until the water temperature reads a selected temperature (i.e., 60 degrees Fahrenheit or more or less) or is within a selected temperature range (i.e., 50 degrees F. to 75 degrees F.) at any point in time or averaged over a selected time period such as 30 seconds, 1 minute, 3 minutes, 5 minutes, 10 minutes, or more or less or any time therebetween.

The snow sensor 320 may be an infrared (“IR”) sensor, a thermal sensor, a radar sensor, an ultrasonic sensor, or a capacitive and/or conductive sensor. The IR sensor may be integrated into the UV-C cleaning assembly to determine presence and locations of snow and/or ice and water via differences in reflectively. The thermal sensor may sense presence of snow by detecting temperature across surface of the vessel. The temperature sensing may be integrated into the flexible heater assembly at multiple locations to detect temperature differential of snow, water, or air in contact with the vessel walls. The radar sensor may use an mmWave radar integrated circuit that is integrated with the UV-C cleaning assembly to sense snow throughout the vessel. The ultrasonic sensor may likewise be integrated with the UV-C cleaning assembly to detect presence of snow or water above the sensors. Finally, the capacitive or conductive sensor uses electrodes inside the vessel to detect changes in capacitance or conductivity, respectively, in areas where the electrodes contact snow and/or ice, water, or air.

Thus, the microcontroller 302 activates the melt cycle based on input from the user to the button 322A and maintains the melt cycle until snow is no longer detected by the snow sensor 320 in some implementations. When the user activates the snow melt button 322A, the microcontroller may activate and LED indicator 322C to provide feedback to the user that the melt cycle is running or has been activated. The LED indicator can be a further LED array that corresponds to or is associated with the melt cycle button 322A (i.e., a ring of light around the melt cycle button 322A) or is a separate array positioned proximate the melt cycle button 322A, such as a tri-color LED indicator capable of providing feedback to the user in the form of different patterns of flashing light and/or in three different colors of light.

The user interface 322 further includes a UV Start button 322B that controls operation of the UV-C cleaning system. Specifically, when the user depresses the UV Start button 322B, the microcontroller 302 receives a signal to start a UV-C cleaning cycle. The microcontroller 302 may then first reference the UV safety sensor 320 to determine that the lid is secured to the vessel based on feedback from the UV safety sensor 320 such that is safe to start the cycle. If the UV safety sensor 320 indicates the lid is not on the vessel, then the microcontroller 302 does not initiate the cleaning cycle and provides feedback to the user via the LED indicator 322C, such as a light in a different color or a certain sequence of light flashes to determine that the cleaning cycle was not started. Assuming the UV safety sensor 320 indicates the lid is secured to the vessel, then the microcontroller 302 activates the LED driver 312 with power provided by the BMS, which in turn drives and activates the UV-C LED array 316 for the cleaning cycle, which again may be 60 seconds or a different select time (i.e., 45 seconds, 1 minute 30 seconds, or others).

In an implementation, the controller 300 further includes an accelerometer or other sensor capable of determining an orientation of the water bottles 100, 200 and the microcontroller 302 is configured to determine, via stored instructions or an algorithm, a subsequent orientation of the snow due to gravity. The microcontroller 302 may use the orientation of the snow to activate or deactivate certain aspects, such as different sections of the heater system 314, to optimize heating.

Thus, in sum, the system control is provided by the microcontroller 302, which monitors user input to the user interface 322 and provides feedback to the user through LED indicators 322C or other notification devices, such as speakers, buzzers, vibration, etc. The microcontroller 302 controls and monitors the snow melting cycle based on feedback from the snow sensor 320 and also controls and monitors the UV cleaning cycle based on feedback from the UV safety sensor 318. The power system includes the battery 304, BMS 306, USB charge port 308, and converters 310 to provide power to the system, such as to the LED Driver 312, which in turn provides constant current to the UV-C LED array 316, and to the heater system 314. The heater system 314 may be any of the heaters described herein and includes heating elements and power control, snow detection sensing, and provides heater temperature feedback to the microcontroller 302 to assist with microcontroller 302 management of the same. The UV-C cleaning system includes the UV-C LED array 316, the LED driver 312, and the UV safety sensor 318 that are controlled by the microcontroller 302 to enable UV-C cleaning of the water in the vessel. Thus, the water bottle 200 and controller 300 provide additional functionality, benefits, and advantages.

The present disclosure also contemplates related methods to the devices and systems for storing water and heating snow and/or ice to produce additional water to conserve space and weight in a pack described above.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the water bottle context, and are not limited to the example systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with water bottle devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a water bottle may refer to one water bottle. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A device, comprising:
a portable water bottle, including:
a base;
a container coupled to the base;
a heating element within the container; and
a lid removably coupled to the container to selectively provide access to the container,
wherein the lid is a scoop for assisting with loading of snow or ice, or both, into the container to produce additional drinking water via the heating element or to heat liquid water in the container.

2. The device of claim 1, wherein the base is coupled to the container, the portable water bottle further including:
a battery received in the base and in electronic communication with the heating element; and
a switch or button on an outer surface of the at least one of the base and the container, the switch or button in electronic communication with the battery to selectively turn the heating element ON and OFF or to selectively start or stop a melting cycle.

3. The device of claim 1, wherein the lid includes an elongated portion having a length greater than a circumference of the lid, and
wherein the lid has a cylindrical shape with a diagonal bevel that defines the elongated portion, the diagonal bevel of the lid being at an angle between and including 30 degrees and 60 degrees relative to horizontal.

4. The device of claim 1, wherein the container is a double-walled vessel including:
an outer vessel;
an inner vessel received inside of the outer vessel and configured to contain the snow, ice, liquid water, or any combination thereof;
a space between the outer vessel and the inner vessel; and
at least one heating element around an exterior surface of the inner vessel.

5. The device of claim 4, wherein the at least one heating element is a flexible polyamide heating element, the device further comprising:
insulation in the space between the outer vessel and the inner vessel and surrounding the at least one heating element.

6. The device of claim 1, wherein the portable water bottle is configured to provide an amount of drinking water that is greater than a volume of the portable water bottle via melting of snow or ice, or both, over a plurality of melting cycles.

7. The device of claim 1, further comprising:
a controller in the base and in electrical communication with the heating element, the controller including:
a microcontroller;
an LED driver in communication with the microcontroller;
a UV-C LED array in communication with the LED driver; and
a UV safety sensor in communication with the microcontroller,
wherein the microcontroller is configured to activate a UV-C cleaning cycle by providing instructions to the LED driver to drive the UV-C LED array in response to user input and feedback from the UV safety sensor that the lid is coupled to the container.

8. The device of claim 1, further comprising:
a controller in the base and in electrical communication with the heating element, the controller including:
a microcontroller; and
a snow sensor in electrical communication with the microcontroller,
wherein the microcontroller is configured to activate a melting cycle in response to user input, and
wherein the microcontroller is further configured to terminate the melting cycle in response to feedback from the snow sensor that all of the snow or ice, or both, has been melted.

9. The device of claim 1, further comprising:
a controller in the base and in electrical communication with the heating element, the controller including:
a microcontroller;
a UV-C cleaning subsystem including a UV safety sensor in electrical communication with the microcontroller; and
a snow sensor in electrical communication with the microcontroller,
wherein the microcontroller is configured to activate the UV-C cleaning subsystem to perform a UV-C cleaning cycle in response to user input and feedback from the UV safety sensor that the lid is coupled to the container, and
wherein the microcontroller is configured to activate a melting cycle in response to user input and to terminate the melting cycle in response to feedback from the snow sensor that all of the snow or ice, or both, has been melted.

10. A device, comprising:
a portable water bottle, including:
a double-walled vessel including a space between an outer vessel and an inner vessel received in the outer vessel;
at least one heating element in the space and positioned around at least a portion of an exterior surface of the inner vessel; and
a lid removably coupled to the double-walled vessel to selectively provide access to the inner vessel,
wherein the lid has an elongated body to assist with loading of snow or ice, or both, into the inner vessel.

11. The device of claim 10, wherein the portable water bottle further includes insulation in the space between the outer vessel and the inner vessel, the insulation surrounding the at least one heating element.

12. The device of claim 10, wherein the at least one heating element is four heating elements or includes four sections,
wherein each of the heating elements or each of the sections are spaced from each along a height of the inner vessel.

13. The device of claim 10, wherein the portable water bottle includes a controller in electrical communication with the at least one heating element, the controller including:
a microcontroller;
a UV-C cleaning subsystem including a UV safety sensor in electrical communication with the microcontroller; and
a snow sensor in electrical communication with the microcontroller,
wherein the microcontroller is configured to activate the UV-C cleaning subsystem to perform a UV-C cleaning cycle in response to user input and feedback from the UV safety sensor that the lid is coupled to the container, and
wherein the microcontroller is configured to activate a melting cycle in response to user input and to terminate the melting cycle in response to feedback from the snow sensor that all of the snow or ice, or both, has been melted.

14. A device, comprising:
a portable water bottle, including:
a double-walled vessel including a space between an outer vessel and an inner vessel received in the outer vessel;
at least one heating element in the space and positioned around at least a portion of an exterior surface of the inner vessel;
a lid removably coupled to the double-walled vessel to selectively provide access to the inner vessel; and
a controller in electrical communication with the at least one heating element, including:
a microcontroller; and
a snow sensor in electrical communication with the microcontroller,
wherein the microcontroller is configured to activate a melting cycle in response to user input, and
wherein the microcontroller is further configured to terminate the melting cycle in response to feedback from the snow sensor that snow or ice, or both, in the inner vessel has been melted.

15. The device of claim 14, wherein the at least one heating element includes a plurality of heating elements spaced from each other over a height of the inner vessel.

16. The device of claim 15, wherein the snow sensor is configured to provide feedback to the microcontroller regarding a position or location of the snow or ice, or both, in the inner vessel.

17. The device of claim 16, wherein the microcontroller is configured to selectively activate one or more of the plurality of heating elements corresponding to the determined position or location of the snow or ice, or both, in the inner vessel.

18. The device of claim 14, wherein the controller further includes a UV-C cleaning subsystem including a UV safety sensor in electrical communication with the microcontroller, and
wherein the microcontroller is configured to activate the UV-C cleaning subsystem to perform a UV-C cleaning cycle in response to user input and feedback from the UV safety sensor that the lid is coupled to the double-walled vessel.

19. The device of claim 18, wherein the UV-C cleaning subsystem includes an LED driver in communication with the microcontroller and a UV-C LED array in communication with the LED driver.

20. The device of claim 18, wherein the UV safety sensor is at least one of:
a strain gauge in or on the double-walled vessel to detect when the lid is coupled to the vessel;
a switch in a top of the double-walled vessel that is activated in response to the lid being coupled to the double-walled vessel;
a magnetic switch interface in the double-walled vessel that is activated by a piece of metal in the lid;
a conductive switch including exposed metal contacts on the double-walled vessel; and
an infrared sensor.
